(19) United States
(12) Patent Application Publication
(10) Pub. No.: US 2005/0239956 A1
(43) Pub. Date: Oct. 27, 2005

(54) Polyurethane composition which contains an uretdione group

(75) Inventors: Emmanouil Spyrou, Dorsten (DE); Joern Volker Weiss, Haltern am See (DE); Andreas Wenning, Nottuln (DE); Werner Grenda, Herne (DE); Christoph Lammers, Marl (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 11/115,163

(22) Filed: Apr. 27, 2005

(30) Foreign Application Priority Data
Apr. 27, 2004 (DE) 10 2004 020 429.2

(51) Int. Cl. C08K 3/00

(52) U.S. Cl. 524/589

(57) ABSTRACT

Polyurethane compositions which contain less than 5% by weight of free NCO groups and from 1 to 18% by weight of uretdione groups, can be cured at low temperature and can be used as coating compositions.

### BACKGROUND OF THE INVENTION

1. Field of the Invention

The present invention relates to a polyurethane composition which contains at least one uretdione group.

2. Discussion of the Background

Externally or internally blocked polyisocyanates which are solid at room temperature are valuable crosslinkers for thermally crosslinkable polyurethane (PU) powder coating and adhesive compositions.

For instance, DE-A 27 35 497 describes PU powder coatings having an outstanding weathering stability and thermal stability. The crosslinkers whose preparation is described in DE-A 27 12 931 are composed of α-caprolactam-blocked isophorone diisocyanate containing isocyanurate groups. Also known are polyisocyanates containing urethane, biuret or urea groups, whose isocyanate groups are likewise blocked.

The drawback of these externally blocked systems lies in the elimination of the blocking agent during the thermal crosslinking reaction. Since the blocking agent may thus be emitted to the environment it is necessary on ecological and workplace safety grounds to take particular measures to clean the outgoing air and to recover the blocking agent. The crosslinkers, moreover, are of low reactivity. Curing temperatures above 170° C. are required.

DE-A 30 30 539 and DE-A 30 30 572 describe processes for preparing polyaddition compounds which contain uretdione groups and whose terminal isocyanate groups are irreversibly blocked with monoalcohols or monoamines. Particular drawbacks are the chain-terminating constituents of the crosslinkers, which lead to low network densities in the PU powder coatings and hence to moderate solvent resistances.

Hydroxyl-terminated polyaddition compounds containing uretdione groups are subject matter of EP 0 669 353. Because of their two functionalities they exhibit improved resistance to solvents. Powder coating compositions based on these polyisocyanates containing uretdione groups share the feature that, during the curing reaction, they do not emit any volatile compounds. However, the baking temperatures are at a high level of not less than 180° C.

The use of amidines as catalysts in PU powder coating compositions is described in EP 0 803 524. Although these catalysts do lead to a reduction in the curing temperature they exhibit considerable yellowing, which is generally unwanted in the coatings sector. The cause of this yellowing is presumed to be the reactive nitrogen atoms in the amidines. They are able to react with atmospheric oxygen to form N oxides, which are responsible for the discoloration. EP 0 803 524 also mentions other catalysts which have been used to date for this purpose, but without indicating any particular effect on the curing temperature. Such catalysts include the organometallic catalysts known from polyurethane chemistry, such as dibutyltin dilaurate (DBTL), or else tertiary amines, such as 1,4 diazabicyclo[2.2.2]octane (DABCO), for example.

WO 00/34355 claims catalysts based on metal acetylacetonates: zinc acetylacetonate, for example. Such catalysts are actually capable of lowering the curing temperature of polyurethane powder coating compositions containing uretdione groups, but their reaction products are principally allophanates (M. Gedan-Smolka, F. Lehmann, D. Lehmann “New catalysts for the low temperature curing of uretdione powder coatings” International Waterborne, High solids and Powder Coatings Symposium, New Orleans, Feb. 21-23, 2001). Allophanates are the reaction products of one mole of alcohol and two moles of isocyanate, whereas in the conventional urethane chemistry one mole of alcohol reacts with one mole of isocyanate. As a result of the unwanted formation of allophanate, therefore, isocyanate groups valuable both technically and economically are destroyed.

Certain catalysts so greatly accelerate the unblocking of uretdione groups that when uretdione-group-containing curing agents are used it is possible to achieve a considerable reduction in the curing temperature of powder coating or adhesive compositions. Because of the low curing temperature the melt viscosity is high. This leads to leveling problems and surface defects in the powder coating films. The high glass transition point of conventional PU powder coating base materials can lead, if crosslinking is inadequate, to brittle coatings.

### SUMMARY OF THE INVENTION

It is therefore an object of the present invention to provide high-reactivity polyurethane compositions containing uretdione groups, these compositions being curable even at very low temperatures and being particularly suitable for producing plastics and also for producing high-gloss or matt, light-stable and weather-stable powder coatings and adhesives.

This and other objects have been achieved by the present invention the first embodiment of which includes a high-reactivity polyurethane composition, comprising:
A) at least one polyurethane curing agent which contains at least one uretdione group, the curing agent having a free NCO content of less than 5% by weight and a uretdione content of from 1 to 18% by weight;
B) from 0.001 to 5% by weight, based on the total weight of the composition, of at least one catalyst composition which contains at least one of the following compounds 1, 2, or 3:
   1. a compound of the formula [XR¹R²R³R⁴]⁺ [R⁵COO]⁻,
   wherein X is N or P,
   wherein R¹ to R⁴, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁴ each have 1 to 18 carbon atoms, wherein said R¹ to R⁴ each may be unbridged or bridged with other radicals R¹ to R⁴, to form monocyclic, bicyclic or tricyclic systems,
   wherein bridging atoms between said R¹ to R⁴ are selected from the group consisting of a carbon atom, a heteroatom and combinations thereof,
   wherein, optionally, each radical R¹ to R⁴ may have one or more alcohol groups, amino groups, ester groups, keto groups, thio groups, acid groups, urethane groups, urea groups, allophanate groups, double bonds, triple bonds or halogen atoms, and
   wherein R⁵ is an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R⁵ has 1 to 18 carbon atoms, wherein, R⁵ may have optionally one or more alcohol groups, amino groups, ester groups, keto groups, thio groups, acid groups, urethane groups, urea groups, allophanate groups, double bonds, triple bonds or halogen atoms,
   2. a compound of the formula [XR¹R²R³R⁴]⁺ [R⁵]⁻,
   wherein X is N or P,
   wherein R¹ to R⁴, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁴ each have 1 to 18 carbon atoms, wherein said R¹ to R⁴ each may be unbridged or bridged with other radicals R¹ to R⁴, to form monocyclic, bicyclic or tricyclic systems,
   wherein bridging atoms between said R¹ to R⁴ are selected from the group consisting of a carbon atom, a heteroatom and combinations thereof,
   wherein, optionally, each radical R¹ to R⁴ may have one or more alcohol groups, amino groups, ester groups, keto groups, thio groups, acid groups, urethane groups, urea groups, allophanate groups, double bonds, triple bonds or halogen atoms, and
   R⁵ is OH or F,
   3. a compound of the formula M(OR¹)ₙ(OR²)ₘ(OR³)ₒ(OR⁴)ₚ(OR⁵)_{q}(OR⁶)ᵣ,
   wherein M is a metal in any positive oxidation state and this oxidation state is identical to the sum n+m+o+p+q+r, wherein m, o, p, q, and r are integers from 0 to 6 and wherein the sum n+m+o+p+q+r=1 to 6,
   the radicals R¹ to R⁶, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁶ each have 1 to 8 carbon atoms, wherein said R¹ to R⁶ each may be unbridged or bridged with other radicals R¹ to R⁶, to form monocyclic, bicyclic or tricyclic systems,
   wherein bridging atoms between said R¹ to R⁶ are selected from the group consisting of a carbon atom, a heteroatom and combinations thereof,
   wherein, optionally, each radical R¹ to R⁶ may have one or more alcohol groups, amino groups, ester groups, keto groups, thio groups, acid groups, urethane groups, urea groups, allophanate groups, double bonds, triple bonds or halogen atoms, and
   wherein the compounds 1, 2 or 3, may be present individually or in mixtures, and may be surrounded by an inert shell and hence be encapsulated; and
C) from 1 to 95% by weight of at least one at least partially crystalline, hydroxyl-containing polymer having an OH number of between 10 and 500 mg KOH/g, based on the total weight of the composition;
wherein said composition has a melting point of above 40° C.

In another embodiment the present invention relates to a process for producing a high-reactivity polyurethane composition, comprising:
homogenizing the following components A) to C) and optionally D)-G) at temperatures from 60 to 150° C.:
A) at least one polyurethane curing agent which contains at least one uretdione group, the curing agent having a free NCO content of less than 5% by weight and a uretdione content of from 1 to 18% by weight;
B) from 0.001 to 5% by weight, based on the total weight of the composition, of at least one catalyst composition which contains at least one of the following compounds 1, 2, or 3:
   1. a compound of the formula [XR¹R²R³R⁴]⁺ [R⁵COO]⁻,
   wherein X is N or P,
   wherein R¹ to R⁴, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁴ each have 1 to 18 carbon atoms, wherein said R¹ to R⁴ each may be unbridged or bridged with other radicals R¹ to R⁴, to form monocyclic, bicyclic or tricyclic systems,
   wherein bridging atoms between said R¹ to R⁴ are selected from the group consisting of a carbon atom, a heteroatom and combinations thereof,
   wherein, optionally, each radical R¹ to R⁴ may have one or more alcohol groups, amino groups, ester groups, keto groups, thio groups, acid groups, urethane groups, urea groups, allophanate groups, double bonds, triple bonds or halogen atoms, and
   wherein R⁵ is an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R⁵ has 1 to 18 carbon atoms, wherein, R⁵ may have optionally one or more alcohol groups, amino groups, ester groups, keto groups, thio groups, acid groups, urethane groups, urea groups, allophanate groups, double bonds, triple bonds or halogen atoms,
   2. a compound of the formula [XR¹R²R³R⁴]⁺ [R⁵]⁻,
   wherein X is N or P,
   wherein R¹ to R⁴, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁴ each have 1 to 18 carbon atoms, wherein said R¹ to R⁴ each may be unbridged or bridged with other radicals R¹ to R⁴, to form monocyclic, bicyclic or tricyclic systems,
   wherein bridging atoms between said R to R⁴ are selected from the group consisting of a carbon atom, a heteroatom and combinations thereof,
   wherein, optionally, each radical R¹ to R⁴ may have one or more alcohol groups, amino groups, ester groups, keto groups, thio groups, acid groups, urethane groups, urea groups, allophanate groups, double bonds, triple bonds or halogen atoms, and
   R⁵ is OH or F,
   3. a compound of the formula M(OR¹)ₙ(OR²)ₘ(OR³)ₒ(OR⁴)ₚ(OR⁵)_{q}(OR⁶)ᵣ,
   wherein M is a metal in any positive oxidation state and this oxidation state is identical to the sum n+m+o+p+q+r, wherein m, o, p, q, and r are integers from 0 to 6 and wherein the sum n+m+o+p+q+r=1 to 6,
   the radicals R¹ to R⁶, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁶ each have 1 to 8 carbon atoms, wherein said R¹ to R⁶ each may be unbridged or bridged with other radicals R¹ to R⁶, to form monocyclic, bicyclic or tricyclic systems,
   wherein bridging atoms between said R¹ to R⁶ are selected from the group consisting of a carbon atom, a heteroatom and combinations thereof,
   wherein, optionally, each radical R¹ to R⁶ may have one or more alcohol groups, amino groups, ester groups, keto groups, thio groups, acid groups, urethane groups, urea groups, allophanate groups, double bonds, triple bonds or halogen atoms, and
   wherein the compounds 1, 2 or 3, may be present individually or in mixtures, and may be surrounded by an inert shell and hence be encapsulated; and
C) from 1 to 95% by weight of at least one at least partially crystalline, hydroxyl-containing polymer having an OH number of between 10 and 500 mg KOH/g, based on the total weight of the composition; and
optionally at least one component selected from the group consisting of
D) from 0.1 to 10% by weight of at least one compound which is reactive toward acid groups, based on the total weight of the composition;
E) from 0.1 to 10% by weight of at least one acid in monomeric or polymeric form, based on the total weight of the composition;
F) from 1 to 95% by weight of at least one amorphous, hydroxyl-containing or amino-containing polymer having an OH number of between 20 and 500 mg KOH/g, based on the total weight of the composition;
G) from 0.01 to 55% by weight, based on the total weight of the composition, of at least one member selected from the group consisting of an auxiliary, an additive, and a further catalyst; and
mixtures thereof.

In yet another embodiment the present invention relates to a catalyst composition, comprising:
at least one of the following compounds 1, 2 or 3:
   1. a compound of the formula [XR¹R²R³R⁴]⁺ [R⁵COO]⁻,
   wherein X is N or P,
   wherein R¹ to R⁴, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁴ each have 1 to 18 carbon atoms, wherein said R¹ to R⁴ each may be unbridged or bridged with other radicals R¹ to R⁴, to form monocyclic, bicyclic or tricyclic systems,
   wherein bridging atoms between said R¹ to R⁴ are selected from the group consisting of a carbon atom, a heteroatom and combinations thereof,
   wherein, optionally, each radical R¹ to R⁴ may have one or more alcohol groups, amino groups, ester groups, keto groups, thio groups, acid groups, urethane groups, urea groups, allophanate groups, double bonds, triple bonds or halogen atoms, and
   wherein R⁵ is an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R⁵ has 1 to 18 carbon atoms, wherein, R⁵ may have optionally one or more alcohol groups, amino groups, ester groups, keto groups, thio groups, acid groups, urethane groups, urea groups, allophanate groups, double bonds, triple bonds or halogen atoms,
   2. a compound of the formula [XR¹R²R³R⁴]⁺ [R⁵]⁻,
   wherein X is N or P,
   wherein R¹ to R⁴, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁴ each have 1 to 18 carbon atoms, wherein said R¹ to R⁴ each may be unbridged or bridged with other radicals R¹ to R⁴, to form monocyclic, bicyclic or tricyclic systems,
   wherein bridging atoms between said R¹ to R⁴ are selected from the group consisting of a carbon atom, a heteroatom and combinations thereof,
   wherein, optionally, each radical R¹ to R⁴ may have one or more alcohol groups, amino groups, ester groups, keto groups, thio groups, acid groups, urethane groups, urea groups, allophanate groups, double bonds, triple bonds or halogen atoms, and
   R⁵ is OH or F,
   3. a compound of the formula M(OR¹)ₙ(OR²)ₘ(OR³)ₒ(OR⁴)ₚ(OR⁵)_{q}(OR⁶)ᵣ,
   wherein M is a metal in any positive oxidation state and wherein M is identical to the sum n+m+o+p+q+r, wherein m, o, p, q, and r are integers from 0 to 6 and wherein the sum n+m+o+p+q+r=1 to 6,
   the radicals R¹ to R⁶, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁶ each have 1 to 8 carbon atoms, wherein said R¹ to R⁶ each may be unbridged or bridged with other radicals R¹ to R⁶, to form monocyclic, bicyclic or tricyclic systems,
   wherein bridging atoms between said R¹ to R⁶ are selected from the group consisting of a carbon atom, a heteroatom and combinations thereof,
   wherein, optionally, each radical R¹ to R⁶ may have one or more alcohol groups, amino groups, ester groups, keto groups, thio groups, acid groups, urethane groups, urea groups, allophanate groups, double bonds, triple bonds or halogen atoms, and
   wherein the compounds 1, 2 or 3, may be present individually or in mixtures, and may be surrounded by an inert shell and hence be encapsulated.

In yet another embodiment the present invention relates to a method for accelerating the curing of a high-reactivity polyurethane composition, comprising:
contacting from 0.001 to 5% by weight, based on the total weight of the composition, of the above catalyst with a composition comprising
following components A), C) and optionally D)-G):
A) at least one polyurethane curing agent which contains at least one uretdione group, the curing agent having a free NCO content of less than 5% by weight and a uretdione content of from 1 to 18% by weight; and
C) from 1 to 95% by weight of at least one at least partially crystalline, hydroxyl-containing polymer having an OH number of between 10 and 500 mg KOH/g, based on the total weight of the composition; and
optionally at least one component selected from the group consisting of
D) from 0.1 to 10% by weight of at least one compound which is reactive toward acid groups, based on the total weight of the composition;
E) from 0.1 to 10% by weight of at least one acid in monomeric or polymeric form, based on the total weight of the composition;
F) from 1 to 95% by weight of at least one amorphous, hydroxyl-containing or amino-containing polymer having an OH number of between 20 and 500 mg KOH/g, based on the total weight of the composition;
G) from 0.01 to 55% by weight, based on the total weight of the composition, of at least one member selected from the group consisting of an auxiliary, an additive, and a further catalyst; and
mixtures thereof.

The present invention also relates to an article, coated with the above polyurethane composition.

### DETAILED DESCRIPTION OF THE INVENTION

Surprisingly, the inventors of the present invention have found that in low-temperature-curing, uretdione-containing systems the use of (partially) crystalline resins not only improves the leveling of the powder coatings but also decisively increases the flexibility of the powder coatings and adhesives.

Conventional uretdione-containing coating and adhesive compositions can be cured only at 180° C. or above under normal conditions (DBTL catalysis, i.e. dibutyltinlaurate catalysis). With the aid of the low-temperature-curing polyurethane compositions of the present invention it is possible, with a curing temperature of 100 to 160° C., not only to save on energy and cure time but also to coat or bond many temperature-sensitive substrates which at 180° C. would give rise to unwanted yellowing, decomposition and/or embrittlement phenomena. The curing temperature includes all values and subvalues therebetween, especially including 105, 110, 115, 120, 125, 130, 135, 140, 145, 150, and 155° C. Besides metal, glass, wood, leather, plastics, and MDF board, certain aluminum substrates are predestined for this application. In the case of the aluminum substrates, an excessively high temperature load sometimes leads to an unwanted change in the crystal structure.

The present invention provides a high-reactivity polyurethane composition containing at least one uretdione group and having a melting point of above 40° C., comprising
A) at least one curing agent which contains at least one uretdione group and is based on the reaction product of 1) an aromatic, aliphatic, (cyclo)aliphatic and/or cycloaliphatic polyisocyanate and 2) a hydroxyl-containing compound, the curing agent having a free NCO content of less than 5% by weight and a uretdione content of from 1 to 18% by weight, an example for the curing agent being a polyurethane having at least one uretdione group;
B) from 0.001 to 5% by weight, based on the total weight of the composition, of at least one catalyst composition which contains at least one of the following compounds 1, 2, or 3:
   1. a compound of the formula [XR¹R²R³R⁴]⁺ [R⁵COO]⁻, X being N or P, wherein R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to include not only carbon but also heteroatoms and, additionally, for each radical R¹ to R⁴ to have one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical having 1 to 18 carbon atoms which is linear or branched and additionally may have one or more alcohol, amino, ester, keto, thio, acid, urethane, urea or allophanate groups, double bonds, triple bonds or halogen atoms;
   2. a compound of the formula [XR¹R²R³R⁴]⁺ [R⁵]⁻, X being N or P, wherein R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to include not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either OH or F,
   3. a compound of the formula M(OR¹)ₙ(OR²)ₘ(OR³)ₒ(OR⁴)ₚ(OR⁵)_{q}(OR⁶)ᵣ, wherein M is a metal in any positive oxidation state and this oxidation state is identical to the sum n+m+o+p+q+r, m, o, p, q, and r are integers from 0 to 6 and the sum n+m+o+p+q+r=1 to 6, the radicals R¹ to R⁶ simultaneously or independently of one another are hydrogen or alkyl, aryl, aralkyl, heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, acid, urethane, urea or allophanate groups, double bonds, triple bonds or halogen atoms,
wherein the compounds 1, 2 or 3, may be present individually or in mixtures, and may be surrounded by an inert shell and hence be encapsulated;
C) from 1 to 95% by weight of at least one at least partially crystalline hydroxyl-containing polymer having an OH number of between 10 and 500 mg KOH/g, based on the total weight of the composition;
D) optionally, from 0.1 to 10% by weight of at least one compound which is reactive toward acid groups, based on the total weight of the composition;
E) optionally, from 0.1 to 10% by weight of at least one acid in monomeric or polymeric form, based on the total weight of the composition;
F) optionally, from 1 to 95% by weight of at least one amorphous, hydroxyl-containing or amino-containing polymer having an OH number of between 20 and 500 mg KOH/g or a comparable amine content, based on the total weight of the composition;
G) optionally, from 0.01 to 55% by weight of auxiliaries and additives and/or further catalysts, based on the total weight of the composition.

The free NCO content includes all values and subvalues between 0 and 5% by weight, especially including 0.5, 1, 1.5, 2, 2.5, 3, 3.5, 4 and 4.5% by weight.

The uretdione content includes all values and subvalues therebetween, especially including 2, 4, 6, 8, 10, 12, 14 and 16% by weight.

The fraction of B) includes all values and subvalues therebetween, especially including 0.005, 0.01, 0.05, 0.1, 0.5, 1, 1.5, 2, 2.5, 3, 3.5, 4 and 4.5% by weight.

The amount of component C) includes all values and subvalues therebetween, especially including 5, 10, 15, 20, 25, 30, 35, 40, 45, 50, 55, 60, 65, 70, 75, 80, 85 and 90% by weight.

The OH number of component C) includes all values and subvalues therebetween, especially including 50, 100, 150, 200, 250, 300, 350, 400 and 450 mg KOH/g.

The amount of component D) includes all values and subvalues therebetween, especially including 0.5, 1, 1.5, 2, 2.5, 3, 3.5, 4, 4.5, 5, 5.5, 6, 6.5, 7, 7.5, 8, 8.5, 9 and 9.5% by weight.

The amount of component E) includes all values and subvalues therebetween, especially including 0.5, 1, 1.5, 2, 2.5, 3, 3.5, 4, 4.5, 5, 5.5, 6, 6.5, 7, 7.5, 8, 8.5, 9 and 9.5% by weight.

The amount of component F) includes all values and subvalues therebetween, especially including 5, 10, 15, 20, 25, 30, 35, 40, 45, 50, 55, 60, 65, 70, 75, 80, 85 and 90% by weight.

The OH number of component F) includes all values and subvalues therebetween, especially including 50, 100, 150, 200, 250, 300, 350, 400 and 450 mg KOH/g.

The amount of component G) includes all values and subvalues therebetween, especially including 0.05, 0.1, 0.5, 1, 2, 3, 4, 5, 10, 15, 20, 25, 30, 35, 40, 45, 50, 55, 60, 65, 70, 75, 80, 85 and 90% by weight.

The present invention also provides a process for preparing the above polyurethane composition.

The present invention also provides a powder coating material and provides for the use of the polyurethane compositions of the present invention for producing coatings on substrates such as metal, plastic, glass, wood or leather or other heat-resistant substrates.

The present invention also provides an adhesive composition and provides for the use of the polyurethane compositions of the present invention for producing adhesive bonds on substrates such as metal, plastic, glass, wood or leather or other heat-resistant substrates.

Likewise provided by the present invention are metal-coating compositions, particularly for automobile bodies, motorbikes and cycles, architectural components and household appliances, wood-coating compositions, glass-coating compositions, leather-coating compositions, and plastics-coating compositions.

Polyisocyanates containing uretdione groups are well known and are described in, for example, U.S. Pat. No. 4,476,054, U.S. Pat. No. 4,912,210, U.S. Pat. No. 4,929,724, and EP 0 417 603. A comprehensive overview of industrially relevant processes for dimerizing isocyanates to uretdiones is offered by J. Prakt. Chem. 336 (1994) 185-200.

Conversion of isocyanates to uretdiones takes place generally in the presence of soluble dimerization catalysts, such as dialkylaminopyridines, trialkylphosphines, phosphoramides or imidazoles, for example. The reaction, conducted optionally in solvents but preferably in their absence, is terminated by addition of catalyst poisons when a desired conversion has been reached. Excess monomeric isocyanate is separated off afterward by short-path evaporation. If the catalyst is sufficiently volatile, the reaction mixture can be freed from the catalyst at the same time as monomer is separated off. In that case there is no need to add catalyst poisons. A broad range of isocyanates is suitable in principle for the preparation of polyisocyanates containing uretdione groups. Preferred for use in accordance with the present invention are isophorone diisocyanate (IPDI), hexamethylene diisocyanate (HDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), methylenediphenyl diisocyanate (MDI), toluidine diisocyanate (TDI) and tetramethylxylylene diisocyanate (TMXDI). More particular preference is given to IPDI and HDI.

The conversion of these polyisocyanates bearing uretdione groups to curing agents A) containing uretdione groups involves the reaction of the free NCO groups with hydroxyl-containing monomers or polymers, such as polyesters, polythioethers, polyethers, polycaprolactams, polyepoxides, polyesteramides, polyurethanes or low molecular mass di-, tri- and/or tetraalcohols as chain extenders and, if desired, monoamines and/or monoalcohols as chain terminators, and has already been frequently described (EP 0 669 353, EP 0 669 354, DE 30 30 572, EP 0 639 598 or EP 0 803 524). Preferred curing agents A) containing uretdione groups have a free NCO content of less than 5% by weight and a uretdione group content of from 1 to 18% by weight (calculated as C₂N₂O₂, molecular weight 84). Preference is given to polyesters and monomeric dialcohols. Besides the uretdione groups, the curing agents may also contain isocyanurate, biuret, allophanate, urethane and/or urea structures. The low molecular weight dialcohols have a molecular weigh in the range of from 62-300 g/mol. The low molecular weight trialcohols have a molecular weigh in the range of from 92-300 g/mol. The low molecular weight tetraalcohols have a molecular weigh in the range of from 136-400 g/mol. The low molecular weight monoamines have a molecular weigh in the range of from 45-300 g/mol. The low molecular weight monoalcohols have a molecular weigh in the range of from 32-300 g/mol.

The present invention also provides for the use of at least one catalyst composition which contains at least one of the following compounds 1, 2, or 3:
1. a compound of the formula [XR¹R²R³R⁴]⁺ [R⁵COO]⁻, X being N or P, wherein R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to include not only carbon but also heteroatoms and, additionally, for each radical R¹ to R⁴ to have one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical having 1 to 18 carbon atoms which is linear or branched and additionally may have one or more alcohol, amino, ester, keto, thio, acid, urethane, urea or allophanate groups, double bonds, triple bonds or halogen atoms;
2. a compound of the formula [XR¹R²R³R⁴]⁺ [R⁵]⁻, X being N or P, wherein R¹ to R⁴ simultaneously or independently of one another are alkyl, aryl, aralkyl, heteroaryl or alkoxyalkyl radicals having 1 to 18 carbon atoms, in each case linear or branched, unbridged or bridged with other radicals R¹ to R⁴, to form monocyclic, bicyclic or tricyclic systems, it being possible for the bridging atoms to include not only carbon but also heteroatoms and, additionally, for each radical R¹ to R⁴ to have one or more alcohol, amino, ester, keto, thio, acid, urethane, urea or allophanate groups, double bonds, triple bonds or halogen atoms, and R⁵ is either OH or F,
3. a compound of the formula M(OR¹)ₙ(OR²)ₘ(OR³)ₒ(OR⁴)ₚ(OR⁵)_{q}(OR⁶)ᵣ, wherein M is a metal in any positive oxidation state and is identical to the sum n+m+o+p+q+r, m, o, p, q, and r are integers from 0 to 6 and the sum n+m+o+p+q+r=1 to 6, the radicals R¹ to R⁶ simultaneously or independently of one another are hydrogen or alkyl, aryl, aralkyl, heteroaryl or alkoxyalkyl radicals having 1 to 8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, acid, urethane, urea or allophanate groups, double bonds, triple bonds or halogen atoms,
   wherein the compounds 1, 2 or 3, may be present individually or in mixtures, and may be surrounded by an inert shell and hence be encapsulated; in solid polyurethane compositions of the above-described kind.

Examples of compound 1. above are tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate, tetrabutylammonium benzoate, tetrabutylphosphonium acetate, tetrabutylphosphonium formate, ethyltriphenylphosphonium acetate, tetrabutylphosphonium benzotriazolate, tetraphenylphosphonium phenoxide and trihexyltetradecylphosphonium decanoate.

Examples of compound 2. above are methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride, and benzyltrimethylammonium fluoride, tetrabutylphosphonium hydroxide and tetrabutylphosphonium fluoride.

Examples of compound 3. above are lithium hydroxide, sodium hydroxide, potassium hydroxide, rubidium hydroxide, cesium hydroxide, beryllium hydroxide, magnesium hydroxide, calcium hydroxide, strontium hydroxide, barium hydroxide, aluminum hydroxide, zinc hydroxide, lithium methoxide, sodium methoxide, potassium methoxide, magnesium methoxide, calcium methoxide, barium methoxide, lithium ethoxide, sodium ethoxide, potassium ethoxide, magnesium ethoxide, calcium ethoxide, barium ethoxide, lithium propoxide, sodium propoxide, potassium propoxide, magnesium propoxide, calcium propoxide, barium propoxide, lithium isopropoxide, sodium isopropoxide, potassium isopropoxide, magnesium isopropoxide, calcium isopropoxide, barium isopropoxide, lithium 1-butoxide, sodium 1-butoxide, potassium 1-butoxide, magnesium 1-butoxide, calcium 1-butoxide, barium 1-butoxide, lithium 2-butoxide, sodium 2-butoxide, potassium 2-butoxide, magnesium 2-butoxide, calcium 2-butoxide, barium 2-butoxide, lithium isobutoxide, sodium isobutoxide, potassium isobutoxide, magnesium isobutoxide, calcium isobutoxide, barium isobutoxide, lithium tert-butoxide, sodium tert-butoxide, potassium tert-butoxide, magnesium tert-butoxide, calcium tert-butoxide, barium tert-butoxide, lithium phenoxide, sodium phenoxide, potassium phenoxide, magnesium phenoxide, calcium phenoxide, and barium phenoxide.

Compounds 1, 2 and 3 may be used in mixtures containing at least two of 1, 2 or 3. The catalysts are present in an amount of from 0.001 to 5% by weight, preferably from 0.01 to 3% by weight, based on the total amount of the components, in the polyurethane composition. The catalysts may include water of crystallization, in which case such water is not taken into account when calculating the amount of catalyst used: that is, the amount of water is removed from the calculation. Particular preference is given to using tetraethylammonium benzoate and tetrabutylammonium hydroxide.

One embodiment of the present invention includes the polymeric attachment of such catalysts B) to the curing agents A) or to hydroxyl-containing polymers C) or F) as well. For example, free alcohol, thio or amino groups of the ammonium salts can be reacted with acid, isocyanate or glycidyl groups of the powder coatings curing agents A) or hydroxyl-containing polymers C) or F) in order to integrate the catalysts B) into the polymeric system. These catalysts may also be surrounded by a shell and so encapsulated.

In the case of the hydroxyl-containing, at least partially crystalline polymers C) it is preferred to use polyesters, polyethers, polyacrylates, polyurethanes, polyethers and/or polycarbonates having an OH number of from 10 to 500 (in mg KOH/g). Particular preference is given to hydroxyl-containing polyesters having an OH number of from 15 to 150 or 30 to 150 mg KOH/g and an average molecular weight of from 500 to 6000 g/mol. The average molecular weight includes all values and subvalues therebetween, especially including 1000, 1500, 2000, 2500, 3000, 3500, 4000, 4500, 5000 and 5500 g/mol. Mixtures of such polymers can also be used. The weight fraction of this at least partially crystalline component C) as a proportion of the total formula A-G can amount to between 1 and 95% by weight, preference being given to from 2 to 50% by weight.

At least partially crystalline, hydroxyl-containing polyesters are prepared by polycondensation. For that purpose an acid component, containing from 80 to 100 mol percent of a saturated linear aliphatic or cycloaliphatic dicarboxylic acid having 4 to 14 carbon atoms and from 0 to 20 mol % of another aliphatic or cycloaliphatic or aromatic dicarboxylic or polycarboxylic acid, is reacted with an alcohol component, containing from 80 to 100 mol percent of a linear aliphatic diol having 2 to 15 carbon atoms and from 0 to 20 mol % of another aliphatic or cycloaliphatic diol or polyol having 2 to 15 carbon atoms.

The amount of saturated linear aliphatic or cycloaliphatic dicarboxylic acid having 4 to 14 carbon atoms includes all values and subvalues therebetween, especially including 82, 84, 86, 88, 90, 92, 94, 96 and 98 mol %.

The amount of another aliphatic or cycloaliphatic or aromatic dicarboxylic or polycarboxylic acid includes all values and subvalues therebetween, especially including 2, 4, 6, 8, 10, 12, 14, 16, and 18 mol %.

The amount of linear aliphatic diol having 2 to 15 carbon atoms includes all values and subvalues therebetween, especially including 82, 84, 86, 88, 90, 92, 94, 96 and 98 mol %.

The amount of another aliphatic or cycloaliphatic diol or polyol having 2 to 15 carbon atoms includes all values and subvalues therebetween, especially including 2, 4, 6, 8, 10, 12, 14, 16, and 18 mol %.

The at least partially crystalline, hydroxyl-containing polyesters thus prepared have preferably an OH number of from 15 to 150 mg KOH/g, an acid number<5 mg KOH/g and a melting point of from 40 to 130° C. The OH number includes all values and subvalues therebetween, especially including 20, 40, 50, 60, 70, 80, 90, 100, 110, 120, 130, and 140 mg KOH/g. The acid number includes all values and subvalues between 0 and <5 mg KOH/g, especially including 0.1, 0.5, 1, 1.5, 2, 2.5, 3, 3.5, 4 and 4.5 mg KOH/g. The melting point includes all values and subvalues therebetween, especially including 50, 60, 70, 80, 90, 100, 110, and 120° C.

Carboxylic acids preferred for preparing (partially) crystalline polyesters are succinic acid, adipic acid, suberic acid, azelaic acid, sebacic acid, dodecanedioic acid, tetrahydrophthalic acid, hexahydrophthalic acid, hexahydroterephthalic acid, endomethylenetetrahydrophthalic acid, glutaric acid, and—where available—their anhydrides. Particular preferred is dodecanedioic acid.

Suitable polyols are the following diols: ethylene glyol, propane-1,2-diol and -1,3-diol, 2,2-dimethylpropane-1,3-diol, butane-1,4-diol, pentane-1,5-diol, hexane-1,6-diol, 2 methylpentane-1,5-diol, 2,2,4-trimethylhexane-1,6-diol, 2,4,4-trimethylhexane-1,6-diol, heptane-1,7-diol, decane-1,10-diol, dodecane-1,12-diol, 9,10-octadecene-1,12-diol, octadecane-1,18-diol, 2,4-dimethyl-2-propylheptane-1,3-diol, butene-1,4-diol, butyne-1,4-diol, diethylene glycol, triethylene glycol, tetraethylene glycol, trans- and cis-1,4-cyclohexanedimethanol, the triols glycerol, hexane-1,2,6-triol, 1,1,1-trimethylolpropane and 1,1,1-trimethylolethane, and the tetraol pentaerythritol.

The activity of the catalysts under B) decreases significantly in the presence of acids. The conventional reaction partners of the uretdione-containing coatings or adhesives curing agents include hydroxyl-containing polyesters. Because of the way in which polyesters are prepared, they occasionally still include acid groups to a small extent. In the presence of polyesters which carry such acid groups it is appropriate either to use the catalysts mentioned in excess, relative to the acid groups, or else to add reactive compounds which are capable of scavenging acid groups. Both monofunctional and polyfunctional compounds can be used for this purpose.

Reactive acid-scavenging compounds D) are, for example, epoxy compounds, carbodiimides, hydroxyalkylamides or 2-oxazolines, but also inorganic salts such as hydroxides, hydrogencarbonates or carbonates. They react with acid groups at elevated temperatures. Preferred examples include triglycidyl ether isocyanurate (TGIC), EPIKOTE® 828 (diglycidyl ether based on bisphenol A, Shell), Versatic acid glycidyl esters, ethylhexyl glycidyl ether, butyl glycidyl ether, Polypox R 16 (pentaerythritol tetraglycidyl ether, UPPC AG), and other Polypox grades containing free epoxy groups, Vestagon EP HA 320, (hydroxyalkylamide, Degussa AG), but also phenylenebisoxazoline, 2-methyl-2-oxazoline, 2-hydroxyethyl-2-oxazoline, 2-hydroxypropyl-2-oxazoline, 5-hydroxypentyl-2-oxazoline, barium hydroxide, sodium carbonate, and calcium carbonate. It will be appreciated that mixtures of such substances are also suitable. These reactive compounds can be used in weight fractions of from 0.1 to 10%, preferably from 0.5 to 3%, based on the total weight of the composition.

Acids specified under E) are all substances, solid or liquid, organic or inorganic, monomeric or polymeric, which possess the properties of a Brönsted acid or a Lewis acid. Examples that may be mentioned include the following: sulfuric acid, acetic acid, benzoic acid, malonic acid, and terephthalic acid, and also copolyesters or copolyamides having an acid number of at least 20. They are present in a weight fraction of from 0.1 to 10%, based on the total weight of the composition.

For the hydroxyl-containing amorphous polymers F) it is preferred to use polyesters, polyethers, polyacrylates, polyurethanes, polyethers and/or polycarbonates having an OH number of from 20 to 500 (in mg KOH/g). Particular preference is given to hydroxyl-containing polyesters having an OH number of from 20 to 150 and an average molecular weight of from 500 to 6000 g/mol. The average molecular weight includes all values and subvalues therebetween, especially including 1000, 1500, 2000, 2500, 3000, 3500, 4000, 4500, 5000 and 5500 g/mol. Mixtures of such polymers can also be used. Amorphous polymers of this kind can be used in a weight fraction of from 1 to 95%, based on the total weight of the composition.

Further, it is possible to add the additives G) customary in coatings or adhesives technology, such as leveling agents, e.g., polysilicones or acrylates, light stabilizers, e.g., sterically hindered amines, or other auxiliaries, as described in EP 0 669 353, for example, in a total amount of from 0.05 to 5% by weight. Fillers and pigments, such as titanium dioxide, for example, can be added in an amount up to 50% by weight of the total composition.

Optionally additional catalysts such as are already known in polyurethane chemistry may be present. These are primarily organometallic catalysts, such as dibutyltin dilaurate, or else tertiary amines, such as 1,4 diazabicyclo[2.2.2]octane, for example, in amounts of from 0.001 to 1% by weight. The amount of the primarily organometallic catalysts includes all values and subvalues therebetween, especially including 0.005, 0.01, 0.05, 0.1, 0.2, 0.3, 0.4, 0.5, 0.6, 0.7, 0.8, and 0.9% by weight.

All of the constituents for preparing the polyurethane composition of the present invention can be homogenized in suitable apparatus, such as heatable stirred tanks, kneading apparatus or else extruders, for example, in which upper temperature limits of 120 to 130° C. ought not to be exceeded. After it has been thoroughly mixed, the composition is applied to the substrate by appropriate techniques, such as rolling or spraying. Application of ready-to-spray powders to suitable substrates can take place by the known methods, such as by electrostatic powder spraying or by fluid-bed sintering electrostatically or otherwise. Application is followed by heating of the coated workpieces for the purpose of curing for from 4 to 60 minutes at a temperature of from 60 to 220° C., preferably from 6 to 30 minutes at from 80 to 160° C. The curing time includes all values and subvalues therebetween, especially including 6, 8, 10, 12, 14, 16, 18, 20, 25, 30, 35, 40, 45, 50 and 55 minutes. The curing temperature includes all values and subvalues therebetween, especially including 70, 80, 90, 100, 110, 120, 130, 140, 150, 160, 170, 180, 190, 200, and 210° C.

Having generally described this invention, a further understanding can be obtained by reference to certain specific examples which are provided herein for purposes of illustration only, and are not intended to be limiting unless otherwise specified.

### EXAMPLES

The following materials were used for the preparation of the Examples.

| Ingredients | Product description, manufacturer |
|---|---|
| VESTAGON | curing agent A), uretdione content: 15.9%, m.p.: |
| BF 1540 | 93-112° C., T_{g}: 80° C., DEGUSSA AG, |
| | Coatings & Colorants |
| VESTAGON | curing agent A), uretdione content: 13.5%, m.p.: |
| BF 1320 | 90-115° C., T_{g}: 79° C., DEGUSSA AG, |
| | Coatings & Colorants |
| TBAB | tetrabutylammonium benzoate, Aldrich |
| DYNACOLL | (partially) crystalline OH polyester C), OH number |
| 7330 | 31 mg KOH/g, m.p.: 81° C., DEGUSSA AG, Coatings |
| | & Colorants, |
| DYNACOLL | (partially) crystalline OH polyester C), OH number |
| 7360 | 30 mg KOH/g, m.p.: 55° C., DEGUSSA AG, Coatings |
| | & Colorants, |
| ALFTALAT | amorphous OH polyester F), OH number: 55 mg KOH/g; |
| AN739 | UCB |
| ARALDIT | acid scavenger D) containing epoxide groups, Vantico, |
| PT 912 | |
| KRONOS | titanium dioxide, Kronos |
| 2160 | |
| RESIFLOW | leveling agent, Worlee |
| PV 88 | |

m.p.: melting point;
T_{g}: glass transition point

The following polyurethane compositions were prepared. The amounts are given in % by weight.

A) Unpigmented Systems

| | VESTAGON | Dynacoll | |
|---|---|---|---|
| A) | BF 1540 | 7360 | TBAB |
| 1 | 49 | 50.0 | 1.0 |

B) Pigmented Systems

| | VESTAGON BF | Dynacoll | Alftalat | |
|---|---|---|---|---|
| B) | 1320 | 7330 | AN739 | TBAB |
| 1 | 23.4 | 13.0 | 30.0 | 0.6 |
| C1* | 23.4 | 0 | 43.0 | 0.6 |

*comparative example

Additionally 30.0% by weight of KRONOS 2160, 1.0% by weight of RESIFLOW PV 88 and 2% by weight of Araldit PT 912 were used in each of the pigmented formulations.

General Preparation Instructions for the Powder Coatings:

The comminuted ingredients (powder coating curing agent, catalysts, and leveling agent) are intimately mixed in an edge runner mill and then homogenized in an extruder at 130° C. maximum. The extrudate is cooled, fractionated, and ground to a particle size<100 μm with a pinned-disk mill. Using an electrostatic powder spraying unit, the powder thus prepared is applied at 60 kV to degreased iron panels and baked in a forced-air oven at 150° C. for 30 minutes (film thickness: 70 to 80 μm).

The following powder coatings were produced using the above procedure and their properties were measured.

| | Erichsen | Ball impact | | |
|---|---|---|---|---|
| | cupping | dir/indir | | |
| Examples | [mm] | [inch * lbs] | Smoothness | Remarks |
| A1 | >10 | >80/>80 | 8 | very flexible, good |
| | | | | leveling |
| B1 | >10 | 80/60 | 4 | flexible, adequate |
| | | | | leveling |
| C1* | 1.5 | <10/<10 | 1 | inflexible, very poor |
| | | | | leveling |

*comparative example.
Erichsen cupping was measured according to DIN 53 156.
Ball impact was measured according to ASTM D 2794-93.
Smoothness: 10 optimal, 1 minimal.

German patent application 102 004 020 429.2 filed Apr. 27, 2004, is incorporated herein by reference.

Numerous modifications and variations on the present invention are possible in light of the above teachings. It is therefore to be understood that within the scope of the appended claims, the invention may be practiced otherwise than as specifically described herein.

1. A high-reactivity polyurethane composition, comprising:
A) at least one polyurethane curing agent which contains at least one uretdione group, the curing agent having a free NCO content of less than 5% by weight and a uretdione content of from 1 to 18% by weight;
B) from 0.001 to 5% by weight, based on the total weight of the composition, of at least one catalyst composition which contains at least one of the following compounds 1, 2, or 3:
1. a compound of the formula [XR¹R²R³R⁴]⁺ [R⁵COO]⁻,
wherein X is N or P,
wherein R¹ to R⁴, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁴ each have 1 to 18 carbon atoms, wherein said R¹ to R⁴ each may be unbridged or bridged with other radicals R¹ to R⁴, to form monocyclic, bicyclic or tricyclic systems,
wherein bridging atoms between said R¹ to R⁴ are selected from the group consisting of a carbon atom, a heteroatom and combinations thereof,
wherein, optionally, each radical R¹ to R⁴ may have one or more alcohol groups, amino groups, ester groups, keto groups, thio groups, acid groups, urethane groups, urea groups, allophanate groups, double bonds, triple bonds or halogen atoms, and
wherein R⁵ is an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R⁵ has 1 to 18 carbon atoms, wherein, R⁵ may have optionally one or more alcohol groups, amino groups, ester groups, keto groups, thio groups, acid groups, urethane groups, urea groups, allophanate groups, double bonds, triple bonds or halogen atoms,
2. a compound of the formula [XR¹R²R³R⁴]⁺ [R⁵]⁻,
wherein X is N or P,
wherein R¹ to R⁴, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁴ each have 1 to 18 carbon atoms, wherein said R¹ to R⁴ each may be unbridged or bridged with other radicals R¹ to R⁴, to form monocyclic, bicyclic or tricyclic systems,
wherein bridging atoms between said R to R⁴ are selected from the group consisting of a carbon atom, a heteroatom and combinations thereof,
wherein, optionally, each radical R¹ to R⁴ may have one or more alcohol groups, amino groups, ester groups, keto groups, thio groups, acid groups, urethane groups, urea groups, allophanate groups, double bonds, triple bonds or halogen atoms, and
R⁵ is OH or F,
3. a compound of the formula M(OR¹)ₙ(OR²)ₘ(OR³)ₒ(OR⁴)ₚ(OR⁵)_{q}(OR⁶)ᵣ,
wherein M is a metal in any positive oxidation state and this oxidation state is identical to the sum n+m+o+p+q+r, wherein m, o, p, q, and r are integers from 0 to 6 and wherein the sum n+m+o+p+q+r=1 to 6,
the radicals R¹ to R⁶, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁶ each have 1 to 8 carbon atoms, wherein said R¹ to R⁶ each may be unbridged or bridged with other radicals R¹ to R⁶, to form monocyclic, bicyclic or tricyclic systems,
wherein bridging atoms between said R to R are selected from the group consisting of a carbon atom, a heteroatom and combinations thereof,
wherein, optionally, each radical R¹ to R⁶ may have one or more alcohol groups, amino groups, ester groups, keto groups, thio groups, acid groups, urethane groups, urea groups, allophanate groups, double bonds, triple bonds or halogen atoms, and
wherein the compounds 1, 2 or 3, may be present individually or in mixtures, and may be surrounded by an inert shell and hence be encapsulated; and
C) from to 95% by weight of at least one at least partially crystalline, hydroxyl-containing polymer having an OH number of between 10 and 500 mg KOH/g, based on the total weight of the composition;
wherein said composition has a melting point of above 40° C.

2. The polyurethane composition as claimed in claim 1, wherein said component A) is a reaction product of 1) an aromatic, aliphatic, (cyclo)aliphatic and/or cycloaliphatic polyisocyanate and 2) a hydroxyl-containing compound.

3. The polyurethane composition as claimed in claim 1, further comprising at least one component selected from the group consisting of
D) from 0.1 to 10% by weight of at least one compound which is reactive toward acid groups, based on the total weight of the composition;
E) from 0.1 to 10% by weight of at least one acid in monomeric or polymeric form, based on the total weight of the composition;
F) from 1 to 95% by weight of at least one amorphous, hydroxyl-containing or amino-containing polymer having an OH number of between 20 and 500 mg KOH/g, based on the total weight of the composition; and
mixtures thereof.

4. The polyurethane composition as claimed in claim 1, comprising from 0.01 to 55% by weight, based on the total weight of the composition, of G) at least one member selected from the group consisting of an auxiliary, an additive, a further catalyst and mixtures thereof.

5. The polyurethane composition as claimed in claim 1, comprising uretdione-containing polyurethane curing agents A) obtained from at least one member selected from the group consisting of isophorone diisocyanate (IPDI), hexamethylene diisocyanate (HDI), 2-methylpentane diisocyanate (MPDI), a combination of 2,2,4-trimethylhexamethylene diisocyanate/2,4,4-trimethylhexamethylene diisocyanate (TMDI), norbornane diisocyanate (NBDI), methylenediphenyl diisocyanate (MDI), toluidine diisocyanate (TDI), tetramethylxylylene diisocyanate (TMXDI), and mixtures thereof.

6. The polyurethane composition as claimed in claim 5, comprising uretdione-containing polyurethane curing agents obtained from at least one member selected from the group consisting of IPDI, HDI and mixtures thereof.

7. The polyurethane composition as claimed in claim 1, comprising uretdione-containing polyurethane curing agents A) obtained from at least one hydroxyl-containing compound selected from the group consisting of polyesters, polythioethers, polyethers, polycaprolactams, polyepoxides, polyesteramides, polyurethanes, low molecular weight di-alcohols, low molecular weight tri-alcohols, low molecular weight tetraalcohols, low molecular weight monoamines, low molecular weight monoalcohols, and mixtures thereof.

8. The polyurethane composition as claimed in claim 1, comprising at least one member selected from the group consisting of polyesters, low molecular weight dialcohols and mixtures thereof.

9. The polyurethane composition as claimed in claim 1, comprising as hydroxyl-containing polymer C) at least one member selected from the group consisting of polyesters, polyethers, polyacrylates, polyurethanes, polycarbonates, and mixtures thereof.

10. The polyurethane composition as claimed in claim 1, comprising polyesters having an OH number of from 30 to 150 mg KOH/g and an average molecular weight of from 500 to 6000 g/mol.

11. The polyurethane composition as claimed in claim 1, comprising catalysts B 1) selected from the group consisting of tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate, and tetrabutylammonium benzoate, tetrabutylphosphonium acetate, tetrabutylphosphonium formate, ethyltriphenyl-phosphonium acetate, tetrabutylphosphonium benzotriazolate, tetraphenylphosphonium phenoxide, trihexyltetradecylphosphonium decanoate and mixtures thereof.

12. The polyurethane composition as claimed in claim 1, comprising catalysts B2) selected from the group consisting of methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride, benzyltrimethylammonium fluoride, tetrabutylphosphonium hydroxide, tetrabutylphosphonium fluoride and mixtures thereof.

13. The polyurethane composition as claimed in claim 1, comprising catalysts B3) selected from the group consisting of lithium hydroxide, sodium hydroxide, potassium hydroxide, rubidium hydroxide, cesium hydroxide, beryllium hydroxide, magnesium hydroxide, calcium hydroxide, strontium hydroxide, barium hydroxide, aluminum hydroxide, zinc hydroxide, lithium methoxide, sodium methoxide, potassium methoxide, magnesium methoxide, calcium methoxide, barium methoxide, lithium ethoxide, sodium ethoxide, potassium ethoxide, magnesium ethoxide, calcium ethoxide, barium ethoxide, lithium propoxide, sodium propoxide, potassium propoxide, magnesium propoxide, calcium propoxide, barium propoxide, lithium isopropoxide, sodium isopropoxide, potassium isopropoxide, magnesium isopropoxide, calcium isopropoxide, barium isopropoxide, lithium 1-butoxide, sodium 1-butoxide, potassium 1-butoxide, magnesium 1-butoxide, calcium 1-butoxide, barium 1-butoxide, lithium 2-butoxide, sodium 2-butoxide, potassium 2-butoxide, magnesium 2-butoxide, calcium 2-butoxide, barium 2-butoxide, lithium isobutoxide, sodium isobutoxide, potassium isobutoxide, magnesium isobutoxide, calcium isobutoxide, barium isobutoxide, lithium tert-butoxide, sodium tert-butoxide, potassium tert-butoxide, magnesium tert-butoxide, calcium tert-butoxide, barium tert-butoxide, lithium phenoxide, sodium phenoxide, potassium phenoxide, magnesium phenoxide, calcium phenoxide, barium phenoxide and mixtures thereof.

14. The polyurethane composition as claimed in claim 1, wherein the catalysts are surround with an inert shell and so are encapsulated.

15. The polyurethane composition as claimed in claim 1, wherein component B) is attached polymerically to said component A) or to said component C).

16. The polyurethane composition as claimed in claim 1, comprising as hydroxyl-containing at least partially crystalline polymer C) at least one member selected from the group consisting of polyesters, polyethers, polyacrylates, polyurethanes, polyethers, polycarbonates and mixtures thereof;
wherein said component C) has an OH number of from 10 to 500 mg KOH/g.

17. The polyurethane composition as claimed in claim 16, wherein said OH number is 15 to 150 mg KOH/g and said average molecular weight is 500 to 6000 g/mol.

18. The polyurethane composition as claimed in claim 17, comprising polyesters obtained from a compound selected from the group consisting of succinic acid, adipic acid, suberic acid, azelaic acid, sebacic acid, dodecanedioic acid, tetrahydrophthalic acid, hexahydrophthalic acid, hexahydroterephthalic acid, endomethylenetetrahydrophthalic acid, glutaric acid, an anhydride of succinic acid, an anhydride of adipic acid, an anhydride of suberic acid, an anhydride of azelaic acid, an anhydride of sebacic acid, an anhydride of dodecanedioic acid, an anhydride of tetrahydrophthalic acid, an anhydride of hexahydrophthalic acid, an anhydride of hexahydroterephthalic acid, an anhydride of endomethylenetetrahydrophthalic acid, an anhydride of glutaric acid and mixtures thereof.

19. The polyurethane composition as claimed in claim 17, comprising polyesters obtained from a compound selected from the group consisting of ethylene glyol, propane-1,2-diol, propoane-1,3-diol, 2,2-dimethylpropane-1,3-diol, butane-1,4-diol, pentane-1,5-diol, hexane-1,6-diol, 2 methylpentane-1,5-diol, 2,2,4-trimethylhexane-1,6-diol, 2,4,4-trimethylhexane-1,6-diol, heptane-1,7-diol, decane-1,10-diol, dodecane-1,12-diol, 9,10-octadecene-1,12-diol, octadecane-1,18-diol, 2,4-dimethyl-2-propylheptane-1,3-diol, butene-1,4-diol, butyne-1,4-diol, diethylene glycol, triethylene glycol, tetraethylene glycol, trans-1,4-cyclohexanedimethanol, cis-1,4-cyclohexanedimethanol, triol glycerol, hexane-1,2,6-triol, 1,1,1-trimethylolpropane and 1,1,1-trimethylolethane, tetraol pentaerythritol and mixtures thereof.

20. The polyurethane composition as claimed in claim 1, further comprising as component D) a compound selected from the group consisting of epoxy compounds, carbodiimides, hydroxyalkylamides, basic salts, 2-oxazolines and mixtures thereof.

21. The polyurethane composition as claimed in claim 1, further comprising as acid E) a compound selected from the group consisting of sulfuric acid, acetic acid, benzoic acid, malonic acid, terephthalic acid, copolyesters, copolyamides and mixtures thereof;
wherein said component E) has an acid number of at least 20 mg KOH/g.

22. The polyurethane composition as claimed in claim 1, further comprising as hydroxyl-containing amorphous polymers F) a compound selected from the group consisting of polyesters, polyethers, polyacrylates, polyurethanes, polyethers, polycarbonates and mixtures thereof;
wherein said component F) has an OH number of from 20 to 500 mg KOH/g.

23. A process for producing a high-reactivity polyurethane composition, comprising:
homogenizing the following components A) to C) and optionally D)-G) at temperatures from 60 to 150° C.:
A) at least one polyurethane curing agent which contains at least one uretdione group, the curing agent having a free NCO content of less than 5% by weight and a uretdione content of from 1 to 18% by weight;
B) from 0.001 to 5% by weight, based on the total weight of the composition, of at least one catalyst composition which contains at least one of the following compounds 1, 2, or 3:
1. a compound of the formula [XR¹R²R³R⁴]⁺ [R⁵COO]⁻,
wherein X is N or P,
wherein R¹ to R⁴, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁴ each have 1 to 18 carbon atoms, wherein said R¹ to R⁴ each may be unbridged or bridged with other radicals R¹ to R⁴, to form monocyclic, bicyclic or tricyclic systems,
wherein bridging atoms between said R¹ to R⁴ are selected from the group consisting of a carbon atom, a heteroatom and combinations thereof,
wherein, optionally, each radical R¹ to R⁴ may have one or more alcohol groups, amino groups, ester groups, keto groups, thio groups, acid groups, urethane groups, urea groups, allophanate groups, double bonds, triple bonds or halogen atoms, and
wherein R⁵ is an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R⁵ has 1 to 18 carbon atoms, wherein, R⁵ may have optionally one or more alcohol groups, amino groups, ester groups, keto groups, thio groups, acid groups, urethane groups, urea groups, allophanate groups, double bonds, triple bonds or halogen atoms,
2. a compound of the formula [XR¹R²R³R⁴]⁺ [R⁵]⁻,
wherein X is N or P,
wherein R¹ to R⁴, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁴ each have 1 to 18 carbon atoms, wherein said R¹ to R⁴ each may be unbridged or bridged with other radicals R¹ to R⁴, to form monocyclic, bicyclic or tricyclic systems,
wherein bridging atoms between said R¹ to R⁴ are selected from the group consisting of a carbon atom, a heteroatom and combinations thereof,
wherein, optionally, each radical R¹ to R⁴ may have one or more alcohol groups, amino groups, ester groups, keto groups, thio groups, acid groups, urethane groups, urea groups, allophanate groups, double bonds, triple bonds or halogen atoms, and
R⁵ is OH or F,
3. a compound of the formula M(OR¹)ₙ(OR²)ₘ(OR³)ₒ(OR⁴)ₚ(OR⁵)_{q}(OR⁶)ᵣ,
wherein M is a metal in any positive oxidation state and this oxidation state is identical to the sum n+m+o+p+q+r, wherein m, o, p, q, and r are integers from 0 to 6 and wherein the sum n+m+o+p+q+r=1 to 6,
the radicals R¹ to R⁶, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁶ each have 1 to 8 carbon atoms, wherein said R¹ to R⁶ each may be unbridged or bridged with other radicals R¹ to R⁶, to form monocyclic, bicyclic or tricyclic systems,
wherein bridging atoms between said R¹ to R⁶ are selected from the group consisting of a carbon atom, a heteroatom and combinations thereof,
wherein, optionally, each radical R¹ to R⁶ may have one or more alcohol groups, amino groups, ester groups, keto groups, thio groups, acid groups, urethane groups, urea groups, allophanate groups, double bonds, triple bonds or halogen atoms, and
wherein the compounds 1, 2 or 3, may be present individually or in mixtures, and may be surrounded by an inert shell and hence be encapsulated; and
C) from 1 to 95% by weight of at least one at least partially crystalline, hydroxyl-containing polymer having an OH number of between 10 and 500 mg KOH/g, based on the total weight of the composition; and
optionally at least one component selected from the group consisting of
D) from 0.1 to 10% by weight of at least one compound which is reactive toward acid groups, based on the total weight of the composition;
E) from 0.1 to 10% by weight of at least one acid in monomeric or polymeric form, based on the total weight of the composition;
F) from 1 to 95% by weight of at least one amorphous, hydroxyl-containing or amino-containing polymer having an OH number of between 20 and 500 mg KOH/g, based on the total weight of the composition;
G) from 0.01 to 55% by weight, based on the total weight of the composition, of at least one member selected from the group consisting of an auxiliary, an additive, and a further catalyst; and
mixtures thereof.

24. A powder coating composition, comprising:
the polyurethane composition as claimed in claim 1.

25. An adhesive composition, comprising:
the polyurethane composition as claimed in claim 1.

26. A catalyst composition, comprising:
at least one of the following compounds 1, 2 or 3:
1. a compound of the formula [XR¹R²R³R⁴]⁺ [R⁵COO]⁻,
wherein X is N or P,
wherein R¹ to R⁴, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁴ each have 1 to 18 carbon atoms, wherein said R¹ to R⁴ each may be unbridged or bridged with other radicals R¹ to R⁴, to form monocyclic, bicyclic or tricyclic systems,
wherein bridging atoms between said R¹ to R⁴ are selected from the group consisting of a carbon atom, a heteroatom and combinations thereof,
wherein, optionally, each radical R¹ to R⁴ may have one or more alcohol groups, amino groups, ester groups, keto groups, thio groups, acid groups, urethane groups, urea groups, allophanate groups, double bonds, triple bonds or halogen atoms, and
wherein R⁵ is an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R⁵ has 1 to 18 carbon atoms, wherein, R⁵ may have optionally one or more alcohol groups, amino groups, ester groups, keto groups, thio groups, acid groups, urethane groups, urea groups, allophanate groups, double bonds, triple bonds or halogen atoms,
2. a compound of the formula [XR¹R²R³R⁴]⁺ [R⁵]⁻,
wherein X is N or P,
wherein R¹ to R⁴, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁴ each have 1 to 18 carbon atoms, wherein said R¹ to R⁴ each may be unbridged or bridged with other radicals R¹ to R⁴, to form monocyclic, bicyclic or tricyclic systems,
wherein bridging atoms between said R¹ to R⁴ are selected from the group consisting of a carbon atom, a heteroatom and combinations thereof,
wherein, optionally, each radical R¹ to R⁴ may have one or more alcohol groups, amino groups, ester groups, keto groups, thio groups, acid groups, urethane groups, urea groups, allophanate groups, double bonds, triple bonds or halogen atoms, and
R⁵ is OH or F,
3. a compound of the formula M(OR¹)ₙ(OR²)ₘ(OR³)ₒ(OR⁴)ₚ(OR⁵)_{q}(OR⁶)ᵣ,
wherein M is a metal in any positive oxidation state and wherein M is identical to the sum n+m+o+p+q+r, wherein m, o, p, q, and r are integers from 0 to 6 and wherein the sum n+m+o+p+q+r=1 to 6,
the radicals R¹ to R⁶, simultaneously or independently of one another, are an alkyl radical, an aryl radical, an aralkyl radical, a heteroaryl radical or an alkoxyalkyl radical, each of which may be substituted or unsubstituted, wherein said alkyl radical, aralkyl radical, or alkoxyalkyl radical are linear or branched, wherein said R¹ to R⁶ each have 1 to 8 carbon atoms, wherein said R¹ to R⁶ each may be unbridged or bridged with other radicals R¹ to R⁶, to form monocyclic, bicyclic or tricyclic systems,
wherein bridging atoms between said R¹ to R⁶ are selected from the group consisting of a carbon atom, a heteroatom and combinations thereof,
wherein, optionally, each radical R¹ to R⁶ may have one or more alcohol groups, amino groups, ester groups, keto groups, thio groups, acid groups, urethane groups, urea groups, allophanate groups, double bonds, triple bonds or halogen atoms, and
wherein the compounds 1, 2 or 3, may be present individually or in mixtures, and may be surrounded by an inert shell and hence be encapsulated.

27. A method for accelerating the curing of a high-reactivity polyurethane composition, comprising:
contacting from 0.001 to 5% by weight, based on the total weight of the composition, of the catalyst according to claim 26 with a composition comprising
following components A), C) and optionally D)-G):
A) at least one polyurethane curing agent which contains at least one uretdione group, the curing agent having a free NCO content of less than 5% by weight and a uretdione content of from 1 to 18% by weight; and
C) from 1 to 95% by weight of at least one at least partially crystalline, hydroxyl-containing polymer having an OH number of between 10 and 500 mg KOH/g, based on the total weight of the composition; and
optionally at least one component selected from the group consisting of
D) from 0.1 to 10% by weight of at least one compound which is reactive toward acid groups, based on the total weight of the composition;
E) from 0.1 to 10% by weight of at least one acid in monomeric or polymeric form, based on the total weight of the composition;
F) from 1 to 95% by weight of at least one amorphous, hydroxyl-containing or amino-containing polymer having an OH number of between 20 and 500 mg KOH/g, based on the total weight of the composition;
G) from 0.01 to 55% by weight, based on the total weight of the composition, of at least one member selected from the group consisting of an auxiliary, an additive, and a further catalyst; and
mixtures thereof.

28. A liquid or pulverulent coating or adhesive composition, comprising:
the polyurethane composition according to claim 1.

29. A metal-coating composition, comprising:
the polyurethane composition according to claim 1; and
optionally at least one component selected from the group consisting of
D) from 0.1 to 10% by weight of at least one compound which is reactive toward acid groups, based on the total weight of the composition;
E) from 0.1 to 10% by weight of at least one acid in monomeric or polymeric form, based on the total weight of the composition;
F) from 1 to 95% by weight of at least one amorphous, hydroxyl-containing or amino-containing polymer having an OH number of between 20 and 500 mg KOH/g, based on the total weight of the composition;
G) from 0.01 to 55% by weight, based on the total weight of the composition, of at least one member selected from the group consisting of an auxiliary, an additive, and a further catalyst; and
mixtures thereof.

30. A wood-coating, comprising:
the polyurethane composition according to claim 1; and
optionally at least one component selected from the group consisting of
D) from 0.1 to 10% by weight of at least one compound which is reactive toward acid groups, based on the total weight of the composition;
E) from 0.1 to 10% by weight of at least one acid in monomeric or polymeric form, based on the total weight of the composition;
F) from 1 to 95% by weight of at least one amorphous, hydroxyl-containing or amino-containing polymer having an OH number of between 20 and 500 mg KOH/g, based on the total weight of the composition;
G) from 0.01 to 55% by weight, based on the total weight of the composition, of at least one member selected from the group consisting of an auxiliary, an additive, and a further catalyst; and
mixtures thereof.

31. A leather-coating composition, comprising:
the polyurethane composition according to claim 1; and
optionally at least one component selected from the group consisting of
D) from 0.1 to 10% by weight of at least one compound which is reactive toward acid groups, based on the total weight of the composition;
E) from 0.1 to 10% by weight of at least one acid in monomeric or polymeric form, based on the total weight of the composition;
F) from 1 to 95% by weight of at least one amorphous, hydroxyl-containing or amino-containing polymer having an OH number of between 20 and 500 mg KOH/g, based on the total weight of the composition;
G) from 0.01 to 55% by weight, based on the total weight of the composition, of at least one member selected from the group consisting of an auxiliary, an additive, and a further catalyst; and
mixtures thereof.

32. A plastics-coating composition, comprising:
the polyurethane composition according to claim 1; and
optionally at least one component selected from the group consisting of
D) from 0.1 to 10% by weight of at least one compound which is reactive toward acid groups, based on the total weight of the composition;
E) from 0.1 to 10% by weight of at least one acid in monomeric or polymeric form, based on the total weight of the composition;
F) from 1 to 95% by weight of at least one amorphous, hydroxyl-containing or amino-containing polymer having an OH number of between 20 and 500 mg KOH/g, based on the total weight of the composition;
G) from 0.01 to 55% by weight, based on the total weight of the composition, of at least one member selected from the group consisting of an auxiliary, an additive, and a further catalyst; and
mixtures thereof.

33. An article, coated with the polyurethane composition according to claim 1.

34. The article according to claim 33, wherein said polyurethane composition further comprises at least one component selected from the group consisting of
D) from 0.1 to 10% by weight of at least one compound which is reactive toward acid groups, based on the total weight of the composition;
E) from 0.1 to 10% by weight of at least one acid in monomeric or polymeric form, based on the total weight of the composition;
F) from 1 to 95% by weight of at least one amorphous, hydroxyl-containing or amino-containing polymer having an OH number of between 20 and 500 mg KOH/g, based on the total weight of the composition;
G) from 0.01 to 55% by weight, based on the total weight of the composition, of at least one member selected from the group consisting of an auxiliary, an additive, and a further catalyst; and
mixtures thereof.
